(19) United States
(12) Patent Application Publication
(10) Pub. No.: US 2008/0152105 A1
(43) Pub. Date: Jun. 26, 2008

(54) TELEPHONE MANAGEMENT SYSTEM

(75) Inventors: Kazuhiro Sumi, Hino-shi (JP); Hideaki Nakai, Hino-shi (JP); Kazuo Nakano, Niiza-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/960,359

(22) Filed: Dec. 19, 2007

(30) Foreign Application Priority Data
Dec. 26, 2006 (JP) 2006-350018

(51) Int. Cl. H04M 15/00

(52) U.S. Cl. 379/112.01

(57) ABSTRACT

According to one embodiment, a telephone management system includes a telephone exchange apparatus, a management apparatus, and transmission paths which each connect between the telephone exchange apparatus and the management apparatus, the telephone exchange apparatus includes a memory which stores log files, a reader which reads log files to be stored in the memory of the corresponding line interface unit based on connection IDs included in an acquisition request, and a file transmitter which notifies the port IDs included in the acquisition request to the firewall/router, and transmits the log files to the management apparatus via the ports, the management apparatus includes a request transmitter which transmits the acquisition request to the telephone exchange apparatus in response to an instruction input, and a receiver which receives the log files transmitted from the telephone exchange apparatus via the transmission paths in response to the transmission of the acquisition request.

### CROSS-REFERENCE TO RELATED APPLICATIONS

This application is based upon and claims the benefit of priority from Japanese Patent Application No. 2006-350018, filed Dec. 26, 2006, the entire contents of which are incorporated herein by reference.

### BACKGROUND

1. Field

One embodiment of the present invention relates to, for example, a telephone management system which uses a management apparatus such as a personal computer to a telephone exchange apparatus to implement operation management via an Internet Protocol (IP) network.

2. Description of the Related Art

The telephone exchange apparatus detects internal or external abnormalities encountered during processing to record the detection result as log files of errors and/or alarms in a built-in memory of a line-terminal connecting card. When call processing and maintenance of software operates, the exchange apparatus may record transmitted and received messages and their contents as log files in the built-in memory.

Meanwhile, in the exchange apparatus, for collecting the log files on the line-terminal connecting card, a maintenance person goes to an installation location of the exchange apparatus, connects the management apparatus such as a personal computer to the exchange apparatus via a serial port to collect the log files. Therefore, since almost a whole of work, until the collecting of the log files is completed, is performed artificially by the maintenance person, the exchange apparatus needs a long time and a large labor. If the maintenance person is stationed near by the exchange apparatus, it is possible for the maintenance person to conduct the collecting work of the log files quickly. However, in the usual case, the maintenance person is at a remote place from the installation location of the exchange apparatus.

A method of collecting log files to be recorded in a built-in memory of a telephone exchange apparatus by a management apparatus on a communication network in accordance with remote control from the management apparatus in the case in which the exchange apparatus is connected to the network has been presented (e.g., Jpn. Pat. Appln. KOKAI Publication No. 4-237251).

However, in the method, when the management apparatus collets the log files in the exchange apparatus via the network, if the management apparatus opens or closes a transmission and reception port of a firewall or a router on the network more than is necessary, there is the danger that the log files are altered or collected by an unfairly third person.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a preferred block diagram illustrating a telephone management system regarding the first embodiment of the invention;

FIG. 2 is a preferred flowchart illustrating an operational procedure and its content of a telephone exchange apparatus in the first embodiment of the invention; and

FIG. 3 is a preferred block diagram illustrating a configuration of a telephone management system regarding the second embodiment of the invention regarding.

### DETAILED DESCRIPTION

Various embodiments according to the invention will be described hereinafter with reference to the accompanying drawings. In general, according to one embodiment of the invention, a telephone management system comprising: a telephone exchange apparatus which includes a plurality of line interface units to each house local area networks, respectively, and an exchange control unit to be connected to the plurality of line interface units via a control bus including smaller transmission quantity than that of the local area network, the plurality of line interface units are assigned connection IDs, the exchange control unit performs exchange processing among the plurality of line interface units; a management apparatus which performs operation management processing of the telephone exchange apparatus: and transmission paths which each connect between the telephone exchange apparatus and the management apparatus and each include a firewall/router, and open a port corresponding to an instruction from the telephone exchange apparatus among a plurality of ports for information transmission, wherein the telephone exchange apparatus comprises: a memory which is provided for each of the line interface units, and stores log files relating to processing histories and operations of the exchange processing; a reader which reads log files to be stored in the memory of the corresponding line interface unit based on connection IDs included in an acquisition request for log files, when the acquisition request is transmitted from the management apparatus via the transmission paths, the acquisition request includes the connection IDs and port IDs to specify the ports; and a file transmitter which notifies the port IDs included in the acquisition request to the firewall/router to open the corresponding ports, and transmits the log files to the management apparatus via the ports, the management apparatus comprises: a request transmitter which transmits the acquisition request to the telephone exchange apparatus via the transmission paths in response to an instruction input; and a receiver which receives the log files transmitted from the telephone exchange apparatus via the transmission paths in response to the transmission of the acquisition request to record them on a recording medium.

### FIRST EMBODIMENT

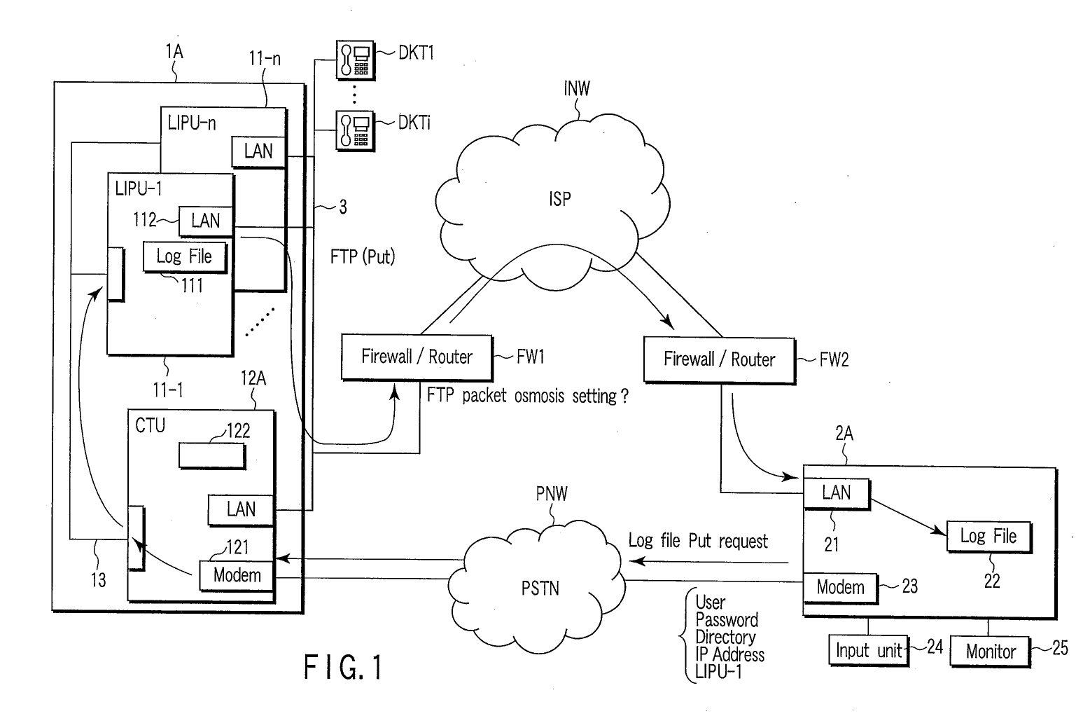

FIG. 1 shows a block diagram showing a configuration of a telephone management system regarding the first embodiment of the invention, the symbol 1A indicates a telephone exchange apparatus and the symbol 2A indicates a management apparatus.

The exchange apparatus 1A includes a plurality of local area network (LAN) interface units (LIPU-1 to LIPU-n) 11-1 to 11-n, and a central control unit (CTU) 12A, and these plurality of LAN interface units 11-1 to 11-n and the control unit 12A are mutually connected via a control bus 13. The plurality of LAN interface units 11-1 to 11-n and the central control unit 12A are mutually connected via a LAN 3 having a larger transmission quantity than that of the bus 13.

A plurality of extension terminals DKT1-DKTi are housed in the plurality of LAN interface units 11-1 to 11-n via the LAN 3. For example, digital key telephone sets are used as the extension terminals DKT1-DKTi. The plurality of LAN interface units 11-1 to 11-n perform transmission and reception processing and transfer processing of digital signals to and from the extension terminals DKT1-DKTi.

The control unit 12A includes usual control functions of call transmission processing accompanied by call requests from each extension terminal DKT1-DKTi, of usual call reception processing accompanied by outside line call receptions from a public switched telephone network (PSTN) PNW, and of transfer processing inter-extension terminal DKT1-DKTi, etc.

The plurality of LAN interface units 11-1 to 11-n and the control unit 12A are connected to a management apparatus 2A via the LAN 3, a firewall/router FW1, an IP network (ISP) INW and a firewall/router FW2. The control unit 12A is connected to the management apparatus 2A via the PSTN PNW.

In the first embodiment, each of the plurality of LAN interface units 11-1 to 11-n includes a log file storage unit (Log File) 111 and a log file transmission unit (LAN) 112.

The storage unit 111 appropriately stores operational history data, history data relating to call processing, data indicating a start procedure, and a log file necessary for maintenance for a line error and a packet loss of the extension terminals DKT1-DKTi.

The transmission unit 112 reads log files stored in the storage unit 111 to transmit the log files onto the IP network INW by using File Transfer Protocol (FTP) in response to a transmission instruction which arrives from the control unit 12A through the bus 13.

The central control unit 12A includes a modem 121 and a log file storage unit 122. The modem 121 communicates with the management apparatus 2A via the PSTN PNW, receives a log file put (acquisition) request transmitted from the management apparatus 2A, and instructs so that the LAN interface unit 11-1 specified in response to the put (acquisition) request to read the log files from the storage unit 111 and to transmit the log files to the management apparatus 2A that is a request origin. At this time, the control unit 12A opens a specified port of the firewall/router FW1.

The log file storage unit 122 stores log files (messages, protocol stacks, call processing data, system management logs) relating to the processing history of the control processing by the control unit 12A.

The management apparatus 2A is composed of a general-purpose personal computer, and has a LAN connecting unit (LAN) 21, a log file storage unit (Log File) 22 and a modem 23. The LAN connecting unit 21 communicates with the telephone exchange apparatus 1A, and receives log files transmitted from the exchange apparatus 1A to store them in the storage unit 22.

The modem 23 communicates with the exchange apparatus 1A via the PSTN PNW, and transmits an acquisition request for the log files to the exchange apparatus 1A in response to the acquisition instruction from an input unit 24.

The input unit 24 is used for inputting a variety of operation instructions to the management apparatus 2A, and is also used for inputting a transmission instruction of the acquisition request for the log files to the exchange apparatus 1A.

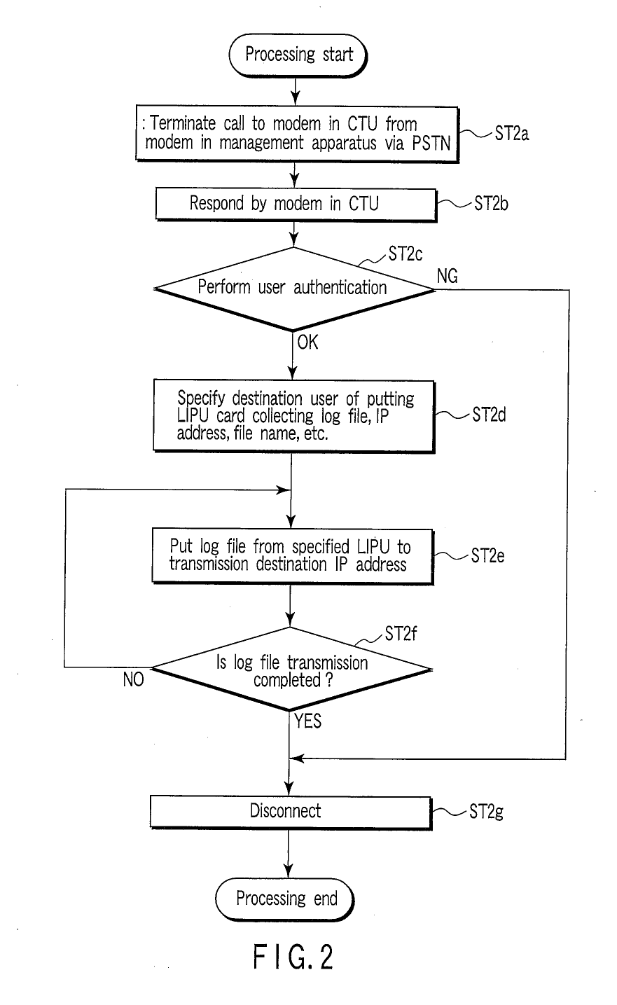

Next, operations of the telephone management system configured as is given above will be described. FIG. 2 shows a flowchart depicting an operation procedure and its content of the exchange apparatus 1A.

At first, it is assumed that a user of the management apparatus 2A uses the management apparatus 2A to transmit a call signal to the exchange apparatus 1A via the PSTN PNW so as to collect the log files. The central control unit 12A of the exchange apparatus 1A then shifts from block ST2a to block ST2b, responds to the call signal there, establishes a communication link through a subscriber telephone line of the PSTN PNW to and from the management apparatus 2A, and implements user authentication (e.g., user ID, password, etc.) to and from the management apparatus 2A (block ST2c).

If the user is authenticated (OK), the control unit 12A of the exchange apparatus 1A transmits input guidance screen information necessary for the acquisition of the log files to the management apparatus 2A via the communication link to display the screen information on a monitor 25 (block ST2d). The user of the management apparatus 2A inputs necessary items related to the acquisition of the log files by means of an input unit 24 in accordance with the guidance of the screen downloaded from the exchange apparatus 1A. The necessary items to be input are control data necessary for FTP connection, an LIPU card number of a log file collecting destination, an IP address assigned to the management apparatus 2A, a port number, a file name, etc. After inputting these necessary items, the management apparatus 2A transmits the acquisition request for the log files including the information of these items toward the control unit 12A of the exchange apparatus 1A.

When receiving the acquisition request, the control unit 12A of the exchange apparatus 1A accesses the firewall/router FW1 to open the port corresponding to the port number included in the acquisition request, and also accesses the LAN interface unit 11-1 corresponding to specified LIPU card number via the control bus 13 to transmit the log files from the LAN port of the specified LAN interface unit 11-1 to the specified destination via the firewall/router FW1, the IP network INW and the firewall/router FW2 (block ST2e), and repeatedly executes processing in block ST2e and block ST2f until the completion of the transmission of the log files.

When completing the transmission of the log files, the control unit 12A of the exchange apparatus 1A disconnects the communication link (block ST2g).

In block ST2c, if the user has not been authenticated, the exchange apparatus 1A shifts to block ST2g to disconnect the communication link.

Meanwhile, the management apparatus 2A receives the log files transmitted from the exchange apparatus 1A via the firewall/router FW1, the IP network INW and the firewall/router FW2 to store the received log files in the storage unit 22, and displays them onto the monitor 25.

As mentioned above, in the first embodiment, when the management apparatus 2A specifies the log files of the LAN interface unit 11-1 of which the acquisition is desired, the IP address of the management apparatus 2A and the port number to be used, the management apparatus 2A transmits the acquisition request of the log files to the telephone exchange apparatus 1A. The exchange apparatus 1A then opens the port corresponding to the specified port number of the LAN interface unit 11-1, and transmits the log files of the specified LAN interface unit 11-1 through the specified ports of the LAN 3, the firewall/router FW1, the IP network INW and the firewall/router FW2.

Accordingly, the ports of the firewall/routers FW1 and FW2 are opened only in one direction from the exchange apparatus 1A to the management apparatus 2A, thereby it is not necessary to open the ports of the firewall/routers FW1 and FW2 to receive the log files from the outside, so that the telephone management system may secure the security level of the LAN 3 and the IP network INW as well as may collect the log files of the LAN interface unit 11-1 by means of the management apparatus 2A without having to go to the location at which the exchange apparatus 1A is installed.

### SECOND EMBODIMENT

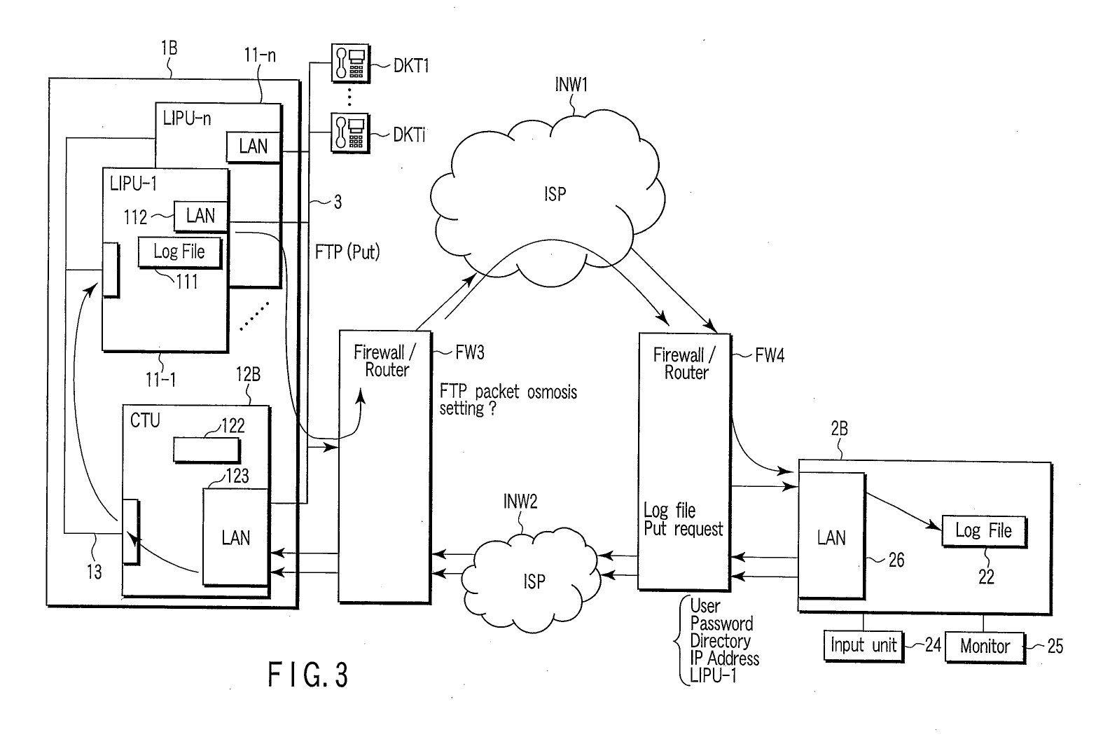

FIG. 3 depicts a block diagram depicting a configuration of a telephone management system regarding the second embodiment of the invention. In FIG. 3, the same components as those of FIG. 1 are designated by the identical symbols and the detailed descriptions thereof will be eliminated.

The plurality of LAN interface units 11-1 to 11-n and a central control unit 12B are connected to a management apparatus 2B via the LAN 3, a firewall/router FW3, an IP network (ISP) INW1 and a firewall/router FW4. The central control unit 12B is connected to the management apparatus 2B via the firewall/router FW3, an IP network (ISP) INW2, and the firewall/router FW4.

In the second embodiment, the control unit 12B includes a LAN connecting unit (LAN) 123. The LAN connecting unit 123 communicates with the management apparatus 2B via the IP networks INW1 and INW2, receives an acquisition request for log files to be transmitted from the management apparatus 2B via the IP network INW2, instructs to the LAN interface unit 11-1 specified in response to the acquisition request so as to read the log files from the log file storage unit 111 to transmit them to the management apparatus 2B that is a request origin. At this time, the specified port of the firewall/router FW3 is opened.

The management apparatus 2B has a LAN connecting unit (LAN) 26. The LAN connecting unit 26 communicates with the exchange apparatus 1B via the IP networks INW1 and INW2, transmits an acquisition request to the exchange apparatus 1B for log files via the IP network INW2 in response to the acquisition instruction from the input unit 24, and also receives the log files to be transmitted via the IP network INW1 to store them in the log file storage unit 22.

Next to this, operations of the telephone management system configured as is given above.

It is assumed that the user of the management apparatus 2B firstly uses the management apparatus 2B so as to collect the log files to transmit a call signal to the exchange apparatus 1B via the IP network INW2. At this moment, the management apparatus 2B opens the specified port of the firewall/router FW4.

The control unit 12B of the exchange apparatus 1B then responds the call to establish a communication link with the management apparatus 2B through the IP network INW2, and performs user authentication (e.g., user ID, password, etc.) to and from the management apparatus 2B.

If the user is authenticated, the control unit 12B of the exchange apparatus 1B transmits input guidance screen information necessary to acquire the log files vie the communication link to the management apparatus 2B to display the information onto the monitor 25. The user of the management apparatus 2B inputs necessary items relating to the acquisition of the log files by means of the input unit 24 in accordance with the guidance of the screen to be downloaded from the exchange apparatus 1B. The necessary items to be input are control data necessary for the FTP connection, LIPU card numbers of log file collecting destinations, an IP address assigned to the management apparatus 2B, port numbers, names of the files, etc. After the inputting of these necessary items, the management apparatus 2B transmits an acquisition request for log files including these items of information to the control unit 12B of the exchange apparatus 1B.

When receiving the acquisition request, the control unit 12B of the exchange unit 1B accesses the firewall/router FW3 to open ports corresponding to the port numbers included in the acquisition request, and also accesses the LAN interface unit 11-1 corresponding to the specified LIPU card number via the control bus 13, and transmits the log files from the LAN port of the specified LAN interface unit 11-1 to the specified destination via the firewall/router FW3, the IP network INW1 and the firewall/router FW4.

When completing the transmission of the log files, the control unit 12B of the exchange apparatus 1B disconnects the communication link.

The management apparatus 2B receives the log files transmitted from the exchange apparatus 1B via the firewall/router FW3, the IP network INW1 and the firewall/router FW4, stores the received log files in the storage unit 22, and also displays them onto the monitor 25.

As mentioned above, in the second embodiment, when the management apparatus 2B specifies the log files of the LAN interface unit 11-1 of which the acquisition is desired, the IP address of the management apparatus 2B and the port number to be used, the management apparatus 2B transmits the acquisition request for the log files to the telephone exchange apparatus 1B via the IP network INW2, the exchange apparatus 1B opens the port corresponding to the specified port number of the firewall/router FW3, and transmits the log files of the specified LAN interface unit 11-1 through the specified ports via the firewall/router FW3, the IP network INW1 and the firewall/router FW4.

Thus, even when the public network is not used, it is not necessary for the system to open the port of the firewall/router FW3 to receive log files from the outside of the system, so that the security level of the LAN 3 and the IP network INW1 to be used for log file transfer may be secured.

### OTHER EMBODIMENT

The present invention is not limited to the specific details and representative embodiments shown and described herein. Although each of the foregoing embodiments has been described in the example to transfer the log files of the LAN interface units to the management apparatus, the log files in the central control unit may be collected in a similar connection operational manner.

In each of the aforementioned embodiments, using a general-purpose connecting procedure such as SIP enables collecting log files even in a telephone management system which does not support FTP.

Other than this, in an implementation phase, this invention may be embodied in various forms with respect to a configuration and a kind of a telephone management system, a kind and a configuration of a telephone exchange apparatus, a functional configuration of a management apparatus, a transfer control procedure and content of a log file, etc., without departing from the sprit or scope of the general inventive concept of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone management system comprising:
a telephone exchange apparatus which includes a plurality of line interface units to each house local area networks, respectively, and an exchange control unit to be connected to the plurality of line interface units via a control bus including smaller transmission quantity than that of the local area network, the plurality of line interface units are assigned connection IDs, the exchange control unit performs exchange processing among the plurality of line interface units;
a management apparatus which performs operation management processing of the telephone exchange apparatus: and
transmission paths which each connect between the telephone exchange apparatus and the management apparatus and each include a firewall/router, and open a port corresponding to an instruction from the telephone exchange apparatus among a plurality of ports for information transmission, wherein
the telephone exchange apparatus comprises:
a memory which is provided for each of the line interface units, and stores log files relating to processing histories and operations of the exchange processing;
a reader which reads log files to be stored in the memory of the corresponding line interface unit based on connection IDs included in an acquisition request for log-files, when the acquisition request is transmitted from the management apparatus via the transmission paths, the acquisition request includes the connection IDs and port IDs to specify the ports; and
a file transmitter which notifies the port IDs included in the acquisition request to the firewall/router to open the corresponding ports, and transmits the log files to the management apparatus via the ports,
the management apparatus comprises:
a request transmitter which transmits the acquisition request to the telephone exchange apparatus via the transmission paths in response to an instruction input; and
a receiver which receives the log files transmitted from the telephone exchange apparatus via the transmission paths in response to the transmission of the acquisition request to record them on a recording medium.

2. The telephone management system according to claim 1, wherein the transmission paths connect between an exchange control unit of the telephone exchange apparatus and the management apparatus via a public network, and connect between the plurality of line interface units and the management apparatus via an Internet Protocol network including the firewall/router,
the request transmitter of the management apparatus transmits the acquisition request to the exchange control unit of the telephone exchange apparatus via the public network;
the reader of the telephone exchange apparatus instructs to the corresponding line interface unit to read the log files to be stored in the memory via the control bus by the exchange control unit in response to the acquisition request; and
the file transmitter of the telephone exchange apparatus notifies the port ID included in the acquisition request to the firewall/router by the exchange control unit to open the corresponding port, and transmits the log files via the corresponding port on the IP network by the corresponding line interface unit.

3. The telephone management system according to claim 1, wherein the transmission paths connect among the plurality of line interface units and the management apparatus via a first IP network including a firewall/router and connect between the exchange control unit of the telephone exchange apparatus and the management apparatus via a second IP network different from the first IP network,
the acquisition transmitter of the management apparatus transmits the acquisition request to the telephone exchange apparatus via the second IP network,
the reader of the telephone exchange apparatus instructs to read the log files to be stored in the memory to the corresponding line interface unit via the control buses by the exchange control unit in response to the acquisition request; and
the file transmitter of the telephone exchange apparatus notifies the port ID included in the acquisition request to the firewall/router by the exchange control unit to open the corresponding port, and transmits the log files via the corresponding port on the first IP network by the corresponding line interface unit.

4. The telephone management system according to claim 1, wherein each of the plurality of line interface units include a function to execute Session Initiation Protocol as a data transfer protocol on the transmission path,
the file transmitter of the telephone exchange apparatus notifies the port ID included in the acquisition request to the firewall/router by the exchange control unit to open the corresponding port for FTP transfer and transmit the log files via the corresponding port on the transmission path by the corresponding line interface unit.

5. The telephone management system according to claim 1, wherein each of the plurality of line interface units includes a function to execute Session Initiation Protocol,
the file transmitter of the telephone exchange apparatus makes the corresponding line interface unit transmit the log files on the transmission path by the exchange control unit by using Session Initiation Protocol.

6. The telephone management system according to claim 1, wherein
the exchange control unit includes a memory which stores log files; and
each of the plurality of line interfaces includes a collector which collects log files to be stored in the memory of the exchange control unit via the control bus.
